(19) United States
(12) Patent Application Publication
(10) Pub. No.: US 2021/0150410 A1
(43) Pub. Date: May 20, 2021

(54) Systems and Methods for Predicting Instance Geometry

(71) Applicant: UATC, LLC, San Francisco, CA (US)

(72) Inventors: Justin Liang, Toronto (CA); Namdar Homayounfar, Toronto (CA); Wei-Chiu Ma, Toronto (CA); Yuwen Xiong, Toronto (CA); Raquel Urtasun, Toronto (CA)

(21) Appl. No.: 17/007,667

(22) Filed: Aug. 31, 2020

Related U.S. Application Data
(60) Provisional application No. 63/021,943, filed on May 8, 2020.
(60) Provisional application No. 62/936,450, filed on Nov. 16, 2019.

(51) Int. Cl. G06N 20/00; G06K 9/62; G06T 17/20

(52) U.S. Cl. CPC G06N 20/00; G06T 17/20; G06K 9/6298; G06K 9/6261

(57) ABSTRACT

Systems and methods for predicting instance geometry are provided. A method includes obtaining an input image depicting at least one object. The method includes determining an instance mask for the object by inputting the input image into a machine-learned instance segmentation model. The method includes determining an initial polygon with a number of initial vertices outlining the border of the object within the input image. The method includes obtaining a feature embedding for one or more pixels of the input image and determining a vertex embedding including a feature embedding for each pixel corresponding an initial vertex of the initial polygon. The method includes determining a vertex offset for each initial vertex of the initial polygon based on the vertex embedding and applying the vertex offset to the initial polygon to obtain one or more enhanced polygons.

### RELATED APPLICATION

The present application is based on and claims benefit of U.S. Provisional Patent Application No. 63/021,943 having a filing date of May 8, 2020, and U.S. Provisional Patent Application No. 62/936,450 having a filing date of Nov. 11, 2019, both of which are incorporated by reference herein.

### FIELD

The present disclosure relates generally to machine-learned model technology. In particular, the present disclosure relates to machine-learned model technology for use within autonomous vehicle and/or other types of systems for environment perception and improved control operations.

### BACKGROUND

Robots, including autonomous vehicles, can receive data that is used to perceive an environment through which the robot can travel. Robots can rely on machine-learned models to detect objects within an environment. The effective operation of a robot can depend on accurate object detection provided by the machine-learned models. Various machine-learned training techniques can be applied to improve such object detection.

### SUMMARY

Aspects and advantages of embodiments of the present disclosure will be set forth in part in the following description, or may be learned from the description, or may be learned through practice of the embodiments.

Aspects of the present disclosure are directed to a method for predicting instance geometry. The method includes obtaining an input image including a plurality of datapoints indicative of an environment. The method includes determining an instance mask for an object instance within the environment by inputting the input image to a machine-learned instance segmentation model. The method includes determining one or more initial polygons for the object instance based, at least in part, on the instance mask. The one or more initial polygons include a plurality of initial vertices defining one or more initial edges of the one or more initial polygons. The method includes obtaining a feature embedding including one or more features for one or more datapoints associated with the object instance. The method includes determining a vertex embedding based, at least in part, on the feature embedding and the one or more initial polygons. The vertex embedding is indicative of the locations of one or more of the initial vertices of the one or more initial polygons. The method includes generating one or more enhanced polygons for the object instance based, at least in part, on the vertex embedding and the one or more initial polygons. The one or more enhanced polygons include a plurality of enhanced vertices defining one or more enhanced edges of the one or more enhanced polygons.

Another aspect of the present disclosure is directed to a computing system for predicting instance geometry. The computing system includes one or more processors and one or more non-transitory computer-readable media that collectively store instructions that, when executed by the one or more processors, cause the system to perform operations. The operations include obtaining an instance mask for an object instance within an environment depicted by an input image including a plurality of datapoints. The operations include determining one or more initial polygons for the object instance based, at least in part, on the instance mask. The one or more initial polygons include a plurality of initial vertices defining one or more initial edges of the one or more initial polygons. The operations include obtaining a feature embedding including one or more features for one or more datapoints associated with the object instance. The operations include determining a vertex embedding based, at least in part, on the feature embedding and the one or more initial polygons. The vertex embedding is indicative of the locations of one or more of the initial vertices of the one or more initial polygons. The operations include generating a plurality of vertex offsets by inputting the vertex embedding to a machine-learned deforming model. And, the operations include generating one or more enhanced polygons based, at least in part, on the plurality of vertex offsets and the plurality of initial vertices. The one or more enhanced polygons include a plurality of enhanced vertices defining one or more enhanced edges of the one or more enhanced polygons.

Another aspect of the present disclosure is directed to another computing system for predicting instance geometry. The system includes an image database including a plurality of input images. Each respective input image includes a plurality of respective datapoints indicative of an environment. The system includes a machine-learned instance segmentation model configured to output one or more object instances in response to receiving a respective input image of the plurality of input images. The system includes a memory that stores a set of instructions and one or more processors which are configured to use the set of instructions to obtain an input image from the image database and determine an instance mask for an object instance within an environment of the input image by inputting the input image to the machine-learned instance segmentation model. In addition, the one or more processors are configured to use the set of instructions to determine one or more initial polygons for the object instance based, at least in part, on the instance mask. The one or more initial polygons include a plurality of initial vertices defining one or more initial edges of the one or more initial polygons. Additionally, the one or more processors are configured to use the set of instructions to obtain a feature embedding including one or more features for one or more datapoints associated with the object instance and determine a vertex embedding based, at least in part, on the feature embedding and the one or more initial polygons. The vertex embedding is indicative of the locations of one or more of the initial vertices of the one or more initial polygons. And, the one or more processors are configured to use the set of instructions to generate one or more enhanced polygons for the object instance based, at least in part, on the vertex embedding and the one or more initial polygons. The one or more enhanced polygons include a plurality of enhanced vertices defining one or more enhanced edges of the one or more enhanced polygons.

Other example aspects of the present disclosure are directed to other systems, methods, vehicles, apparatuses, tangible non-transitory computer-readable media, and devices for predicting instance geometry. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system according to example implementations of the present disclosure;

FIG. 2 depicts a data flow diagram for generating one or more enhanced polygons according to example implementations of the present disclosure;

FIG. 3 depicts an example of feature extraction model according to example implementations of the present disclosure;

FIG. 4 depicts an example training scenario according to example implementations of the present disclosure;

FIG. 5 depicts a flowchart diagram for generating an enhanced object according to example implementations of the present disclosure;

FIG. 6 depicts a flowchart diagram for determining a vertex embedding according to example implementations of the present disclosure;

FIG. 7 depicts an example system with various means for performing operations and functions according example implementations of the present disclosure;

FIG. 8 depicts a block diagram of an example computing system according to example embodiments of the present disclosure.

### DETAILED DESCRIPTION

Aspects of the present disclosure are directed to improved systems and methods for instance segmentation such as, for example, for objects within a surrounding environment of an autonomous vehicle. A computing system for an autonomous vehicle can utilize various instance segmentation techniques to detect objects within an environment of a vehicle. For instance, the computing system can find a rough object estimate of an object from input data (e.g., image data, Light Detection and Ranging (LiDAR data), voxelized LiDAR data, etc.) representative of the environment. The systems and methods of the present disclosure can enhance rough object estimates to identify precise outlines of objects within the environment. To do so, one or more initial polygons for an object instance can be obtained by inputting an input image to a machine-learned instance segmentation model, obtaining a coarse mask for the object instance as an output of the machine-learned instance segmentation model, and determining a plurality of initial vertices defining the one or more initial polygons by applying a contouring algorithm to the coarse mask. An object image can be generated from the input image by fitting a bounding box to the object instance and cropping the input image based on the bounding box (e.g., along the boundary of the bounding box). The object image can be input into a machine-learned feature extraction model to receive a feature embedding including one or more features for each datapoint of a plurality of datapoints of the object image. The feature embedding and the one or more initial polygons can be compared to determine a vertex embedding including one or more features for each datapoint corresponding to an initial vertex of the one or more initial polygons. The vertex embedding can be input into a machine-learned deforming model 255 to determine an offset for each initial vertex. The offset can be applied to each initial vertex to determine a plurality of enhanced vertices defining one or more enhanced polygons. In this manner, one or more enhanced polygons can be obtained that precisely identifies the shape of an object instance within an input image. This, in turn, can provide a better understanding of a scene, thereby enhancing perception systems, in general, and improving scene annotation, in particular, by increasing an annotator's confidence in an object instance.

The following describes the technology of this disclosure within the context of an autonomous vehicle for example purposes only. As described herein, the technology described herein is not limited to an autonomous vehicle and can be implemented within other robotic and computing systems, such as those utilizing object detection machine-learned models.

An autonomous vehicle can include a computing system (e.g., a vehicle computing system) with a variety of components for operating with minimal and/or no interaction from a human operator. For example, the computing system can be located onboard the autonomous vehicle and include one or more sensors (e.g., cameras, Light Detection and Ranging (LiDAR), Radio Detection and Ranging (RADAR), etc.), an autonomy computing system (e.g., for determining autonomous navigation), one or more vehicle control systems (e.g., for controlling braking, steering, powertrain), etc. The autonomy computing system can include a number of sub-systems that cooperate to perceive the surrounding environment of the autonomous vehicle and determine a motion plan for controlling the motion of the autonomous vehicle.

The autonomy computing system can include a number of sub-systems that cooperate to perceive the surrounding environment of the autonomous vehicle and determine a motion plan for controlling the motion of the autonomous vehicle. For example, the autonomy computing system can include a perception system configured to perceive one or more objects within the surrounding environment of the autonomous vehicle, a prediction system configured to predict a motion of the object(s) within the surrounding environment of the autonomous vehicle, and a motion planning system configured to plan the motion of the autonomous vehicle with respect to the object(s) within the surrounding environment of the autonomous vehicle. In some implementations, one or more of the number of sub-systems can be combined into one system. For example, an autonomy computing system can include a perception/prediction system configured to perceive and predict a motion of one or more objects within the surrounding environment of the autonomous vehicle.

Each of the subsystems can utilize one or more machine-learned models. For example, a perception system, prediction system, etc. can perceive one or more objects within the surrounding environment of the vehicle by inputting sensor data (e.g., LiDAR data, image data, voxelized LiDAR data, etc.) into one or more machine-learned models. By way of example, the autonomy system can detect one or more objects within the surrounding environment of the vehicle by including, employing, and/or otherwise leveraging one or more machine-learned object detection models. For instance, the one or more machine-learned object detection models can receive sensor data (e.g., image data, LiDAR data, voxelized LiDAR data, etc.) associated with one or more objects within the surrounding environment of the autonomous vehicle and detect the one or more objects within the surrounding environment based on the scene data. For example, the machine-learned object detection models can be previously trained to output a plurality of bounding boxes, classifications, etc. indicative of one or more of the object(s) within a surrounding environment of the autonomous vehicle. In this manner, the autonomy system can perceive the one or more objects within the surrounding environment of the autonomous vehicle based, at least in part, on the one or more machine-learned object detection models.

In some implementations, the one or more machine-learned models can be trained offline using one or more supervised training techniques. By way of example, a training computing system can train the machine-learned models using labelled training data. The training computing system can include and/or be a component of an operations computing system configured to monitor and communicate with an autonomous vehicle. In addition, or alternatively, the training computing system can include and/or be a component of one or more remote computing devices such as, for example, one or more remote servers configured to communicate with an autonomous vehicle.

The training computing system can include and/or have access to a training database including a plurality of input images. The plurality of input images can include one or more labelled input image(s) and/or unlabeled input image(s). The training database, for example, can include an image database including the plurality of input images. Each respective input image can include a plurality of respective datapoints indicative of an environment. In addition, or alternatively, the training database can include ground truth data. The ground truth data can include one or more object instance classifications for one or more input images of the image database. For example, the ground truth data can include one or more ground truth polygons for one or more of the input images. The ground truth polygon(s) can include enhanced polygon(s) for one or more object instances represented by one or more of the input images. In some implementations, the ground truth data can be generated for the one or more input images using one or more machine-learning techniques.

To do so, a computing system can obtain an input image an image database. This can be obtained from a training database (e.g., during training) or from a data store onboard an autonomous vehicle that includes sensor data associated with a surrounding environment of the autonomous vehicle (e.g., acquired via the vehicle's onboard sensor(s)). The input image can include a plurality of datapoints indicative of an environment. For instance, the plurality of datapoints can include a plurality of image pixels of the input image. The computing system can determine an instance mask for an object instance within the environment by inputting the input image to a machine-learned instance segmentation model. For example, the computing system can include and/or have access to a machine-learned instance segmentation model configured to output one or more object instances in response to receiving a respective input image of the plurality of input images. The machine-learned instance segmentation model can include any machine-learned model (e.g., deep neural networks, convolutional neural networks, recurrent neural networks, recursive neural networks, decision trees, logistic regression models, support vector machines, etc.). In some implementations, the machine-learned instance segmentation model can include one or more modified instance segmentation models such as, for example, a unified panoptic segmentation network (UPSNet) model modified with a backbone from a convolution network (e.g., WideResNet38) model and one or more elements of a path aggregation network (PANet) model. In some implementations, the machine-learned instance segmentation model can be pretrained on a database of labelled images (e.g., a common object in context database (COCO)). A deformable convolution network can be used as its backbone.

The computing system can input the input image to the machine-learned instance segmentation model to receive a coarse instance mask for the object instance. In some implementations, the computing system can receive a respective coarse instance mask for each object instance represented by the input image. The instance mask can include a coarse pixel-wise segmentation mask of the object instance. The coarse pixel-wise segmentation mask, for example, can include a plurality of labelled datapoints of the input image. For example, each respective datapoint of the input image can be assigned a respective confidence score indicative of whether the respective datapoint corresponds to a portion of the object instance. The coarse pixel-wise segmentation mask can include a plurality of pixels of the input image associated with a confidence score over a confidence threshold.

The computing system can determine one or more initial polygons for the object instance based on the instance mask (e.g., the coarse pixel-wise segmentation mask). For instance, the computing system can apply a contour algorithm to extract one or more object contours (e.g., mask borders) from the instance mask. The contour algorithm, for example, can include a border following algorithm configured to extract the borders of instance mask. By way of example, the contour algorithm can be configured to trace the borders of the instance mask to determine a rough shape of the object instance (e.g., the one or more initial polygons).

The one or more initial polygons can include a plurality of initial vertices defining one or more initial edges of the one or more initial polygons. The computing system can determine a plurality of initial vertices for the one or more initial polygons based, at least in part, on the one or more object contours. For instance, the plurality of initial vertices can be placed an equal image pixel distance apart along the one or more object contours. As an example, the initial set of vertices can be placed every 10 pixels along the contour (e.g., border of the mask). In this manner, the computing system can initialize the polygon by using the contour algorithm to extract the contours from the instance mask. The computing system can determine the initial set of vertices by placing a respective initial vertex at every 10 pixel distance in the contour. Such dense vertex interpolation can provide a good balance between performance and memory consumption.

The computing system can determine an object image from the input image. The object image can include the one or more datapoints (e.g., pixels) of the plurality of datapoints of the input image. The object image can include, for example, a cropped image from the input image. By way of example, the computing system can crop the input image based, at least in part, on the instance mask. For instance, the computing system can fit a bounding box to the instance mask. In addition, or alternatively, the machine-learned instance segmentation model can output a proposal box for the object instance. The computing system can crop the object image from the input image based at least in part on the bounding box and/or proposal box for the object instance mask.

The object image can include one or more datapoints. By way of example, the one or more datapoints of the object image can include a plurality of pixels. The plurality of pixels can be arranged in a square of equal dimensions. For example, the object image can be resized (e.g., from the input image) to a square of 512 pixels by 512 pixels. As an example, the object image can be resized to an image (H_{c}; W_{c})=(512; 512).

The computing system can obtain a feature embedding including one or more features for one or more datapoints (e.g., the one or more datapoints of the object image) of the plurality of datapoints (e.g., the plurality of datapoints of the input image). For example, computing system can include a machine-learned feature extraction model configured to output one or more features for one or more respective datapoints in response to receiving the respective datapoint(s). The machine-learned feature extraction model can include any machine-learned model (e.g., deep neural networks, convolutional neural networks, recurrent neural networks, recursive neural networks, decision trees, logistic regression models, support vector machines, etc.). In some implementations, the machine-learned feature extraction model can include a feature pyramid network (FPN) that learns to make use of multi-scale features. For instance, the network can be configured to take as input the object image (H_{c}; W_{c}) obtained from the instance initialization stage and output a set of features at different pyramid levels. In this manner, the machine-learned feature extraction model can be configured to capture high curvature and complex shapes.

The computing system can obtain the feature embedding including the one or more features for the one or more datapoints of the plurality of datapoints by inputting the object image to the machine-learned feature extraction model. The feature embedding, for example, can include one or more feature maps (e.g., P₂, P₃, P₄, P₅, P₆, etc.) for each datapoint (e.g., pixel) of the object image. By way of example, the feature embedding can include, for each datapoint of the object image, a set of features (e.g., a feature map) at different pyramid levels. The set of features can include a set of reliable deep features for each pixel of the object image and/or the pixel's coordinates within the object image. In some implementations, the computing system can process a number of feature maps of the feature embedding to get a feature map of 320 layers for each pixel. The computing system can concatenate the feature map of 320 layers to each respective pixel of the object image to obtain a respective feature tensor. In this manner, the computing system can obtain a feature embedding that includes a feature tensor for each datapoint of the one or more datapoints in the object image.

The computing system can determine a vertex embedding based on the feature embedding and the one or more initial polygons. The vertex embedding can include a plurality of embedded vertices indicative of the locations of one or more of the initial vertices of the one or more initial polygons. For example, the plurality of embedded vertices can include an embedded vertex for each initial vertex of the plurality of initial vertices of the one or more initial polygons. By way of example, each initial vertex of the plurality of initial vertices of the one or more initial polygons can correspond to unique vertex coordinates within the object image. The computing system can sample features at the vertex coordinates corresponding to the initial vertices of the one or more initial polygons from the feature tensor for each datapoint of the one or more datapoints in the object image. In this manner, the computing system can obtain a feature tensor from the feature embedding that corresponds to each initial vertex of the one or more initial polygons.

For example, the computing system can build the vertex embedding upon the multi-scale features extracted from the backbone FPN network (e.g., the machine-learned feature extraction model). The computing system can take the P₂, P₃, P₄, P₅, and P₆ feature maps and apply a plurality of (e.g., two, etc.) lateral convolutional layers to each of them in order to reduce the number of feature channels from 256 to 64. Since the feature maps are ¼, ⅛, 1/16, 1/32, and 1/64 of the original scale, the computing system can bilinearly upsample each feature map back to the original size and concatenate them to form a H_{c}×W_{c}×320 feature tensor. In addition, or alternatively, a two channel CoordConv layer can be appended to each vertex. For instance, the channels can represent x and y coordinates with respect to the frame of the object image. In some implementations, the computing system can exploit a bilinear interpolation operation, for example, from a spatial transformer network to sample features at each vertex coordinate corresponding to each initial vertex of the one or more initial polygons to sample a feature tensor for each initial vertex. In this manner, the vertex embedding z can include an embedding with dimensions of N×(320+2) embedded vertices, where N is the number of initial vertices of the one or more initial polygons.

The computing system can generate a plurality of vertex offsets for the one or more initial polygons based on the vertex embedding. The plurality of vertex offsets can include an offset for each initial vertex of the one or more initial polygons. By way of example, each respective initial vertex of the plurality of initial vertices can be indicative of initial coordinates of the input image. A respective vertex offset of the plurality of vertex offsets can include a distance from the respective initial coordinates of a corresponding initial vertex.

For example, the computing system can generate the plurality of vertex offsets by inputting the vertex embedding to a machine-learned deforming model. By way of example, the computing system can include and/or have access to a machine-learned deforming model configured to output a plurality of respective vertex offsets in response to receiving a vertex embedding. The machine-learned deforming model can include any machine-learned model (e.g., deep neural networks, convolutional neural networks, recurrent neural networks, recursive neural networks, decision trees, logistic regression models, support vector machines, etc.). As an example, in some implementations, the machine-learned deforming model can include a self-attending transformer network. The self-attending transformer network can be configured to model dependencies among each of the plurality of embedded vertices of the vertex embedding.

For example, the machine-learned deforming network can take the vertex embedding as an input and, in response, output an offset for each initial vertex of the vertex embedding. The machine-learned deforming network (e.g., the self-attending transformer network) can be configured to model dependencies between each of the plurality of embedded vertices of the vertex embedding. By way of example, the machine-learned deforming network (e.g., the self-attending transformer network) can include three feed forward neural networks configured to transform a vertex embedding into three different values. The computing system can compute weightings between each of the values by taking a softmax over the dot product of two of the values and multiplying by the third.

More particularly, the computing system can leverage an attention mechanism to propagate information across vertices of the one or more initial polygons. By way of example, moving one vertex can result in two edges attached to the vertex being moved as well. The movement of these edges can depend on the position of the neighboring vertices. Each vertex can communicate with one another in order to reduce unstable and overlapping behavior. The computing system can utilize the machine-learned deforming model to represent the intricate dependencies between each vertex. Given the vertex embeddings z, the computing system can use three feed-forward neural networks to transform the vertex embeddings into Q(z), K(z), and V(z), where Q, K, and V represent Query, Key, and Value, respectively. The computing system can compute the weightings between vertices by taking the softmax over the dot product Q(z)K(z)^{T}. The weighting can be multiplied with the keys V(z) to propagate dependencies across all vertices. By way of example, the attention mechanism can be written as:

$$Atten ( Q ( z ) ; K ( z ) ; V ( z ) ) = softmax ( \frac{Q ( z ) {K ( z )}^{T}}{\sqrt{{d}_{k}}} ) V ( z )$$

where dₖ can be dimension of the queries and keys, serving as a scaling factor to prevent extremely small gradients. The operation can be repeated multiple times (e.g., six times). After the last transformer layer, the computing system can feed the output to another feed-forward network that can predict N×2 offsets for each initial vertex of the one or more initial polygons.

The computing system can generate one or more enhanced polygons for the object instance based on the vertex embedding and the one or more initial polygons. The one or more enhanced polygons, for example, can include a plurality of enhanced vertices defining one or more enhanced edges of the one or more enhanced polygons. For instance, the computing system can determine the plurality of enhanced vertices of the one or more enhanced polygons by applying the plurality of vertex offsets to the plurality of initial vertices of the one or more initial polygons. By way of example, in some implementations, the computing system can add the distance of the respective vertex offset to the respective initial coordinates of the corresponding initial vertex. In this manner, the plurality of vertex offsets can be added to the one or more initial polygons to transform the shape of the one or more initial polygons.

In some implementations, the computing system can identify the object associated with the object instance based on the one or more enhanced polygons. By way of example, the computing system can include a plurality of object representations indicative of one or more predefined objects potentially within an environment depicted by the input image. For instance, each object representation can indicate a shape of at least one of the one or more predefined objects. The computing system can compare the one or more enhanced polygons to the plurality of object representations to match the shape of the one or more enhanced polygons to at least one of the predefined objects. The computing system can identify the object associated with the object instance based at least in part on matching the shape of the one or more enhanced polygons to the at least one predefined object.

The machine learned models (e.g., machine-learned instance segmentation model, machine-learned feature extraction model, machine-learned deforming model, etc.) described herein can be trained via one or more machine-learning techniques. For example, the computing system can train the machine-learned deforming model and the machine-learned feature extraction model in an end-to-end manner. For instance, the computing system can minimize the weighted sum of two losses. The first loss can penalize the machine-learned models for when the vertices deviate from the ground truth. The second loss (e.g., a standard deviation loss) can regularize the edges of the one or more enhanced polygons to prevent overlap and unstable movement of the vertices.

By way of example, the computing system can obtain a ground truth polygon corresponding to the object instance of the input image (e.g., from the training database). The computing system can determine a ground truth loss for the machine-learned deforming model based on a comparison between the ground truth polygon and the one or more enhanced polygons. For example, the computing system can determine a ground truth loss based on the ground truth polygon and the one or more enhanced polygons and train the machine-learned deforming model to minimize the ground truth loss.

More particularly, in some implementations, the computing system can use a Chamfer Distance loss to move the vertices of the one or more enhanced polygons P closer to the ground truth polygon Q. The Chamfer Distance loss can be defined as:

$${L}_{c} ( P , Q ) = \frac{1}{\vert P \vert} {\sum }_{i} {min}_{q ∈ Q} {‖ {p}_{i} - q ‖}_{2} + \frac{1}{\vert Q \vert} {\sum }_{j} {min}_{p ∈ P} {‖ p - {q}_{j} ‖}_{2}$$

where p and q can be the rasterized edge pixels of the one or more enhanced polygons, P, and the ground truth polygon, Q, respectively. The first term of the loss can penalize the machine-learned models when P is far from Q and the second term can penalize the models when Q is far from P.

In addition, or alternatively, the computing system can obtain a standard deviation loss for the one or more enhanced polygons. The standard deviation loss can be indicative of an average displacement of a distance between each of the enhanced vertices. In some implementations, the computing system can train the machine-learned deforming model to minimize the standard deviation loss. By way of example, in order to prevent unstable movement of the vertices, the computing system can add a standard deviation loss on the lengths of the edges between the vertices. The standard deviation loss can be defined as.

$${L}_{s} ( P ) = \sqrt{\frac{Σ {‖ e - \overline{e} ‖}_{2}}{n}} ,$$

where ē denotes the mean length of the edges. In this manner, the machine-learned models described herein can be learned to generate enhanced polygons indicative of the precise, uniform shape of one or more object instances represented by an input image.

Example aspects of the present disclosure can provide a number of improvements to perception computing technology and robotics computing technology such as, for example, perception computing technology for autonomous driving. For instance, the systems and methods of the present disclosure provide an improved approach for object annotation of training images for large scale image databases and for detecting object within a surrounding environment of an autonomous vehicle. For example, a computing system can obtain an input image including a plurality of datapoints indicative of an environment. The computing system can determine an instance mask for an object instance within the environment by inputting the input image to a machine-learned instance segmentation model. The computing system can determine one or more initial polygons for the object instance based, at least in part, on the instance mask. The one or more initial polygons can include a plurality of initial vertices defining one or more initial edges of the one or more initial polygons. The computing system can obtain a feature embedding including one or more features for one or more datapoints associated with the object instance. The computing system can determine a vertex embedding based, at least in part, on the feature embedding and the one or more initial polygons. The vertex embedding can be indicative of the locations of one or more of the initial vertices of the one or more initial polygons. And, the computing system can generate one or more enhanced polygons for the object instance based, at least in part, on the vertex embedding and the one or more initial polygons. The one or more enhanced polygons can include a plurality of enhanced vertices defining one or more enhanced edges of the one or more enhanced polygons. In this manner, the present disclosure presents an improved computing system that can effectively generate enhanced object shapes for object classification.

The computing system can accumulate and utilize newly available information in the form of enhanced object polygons to provide a practical improvement to machine-learning technology (e.g., machine-learning annotation technology). The enhanced object polygons present a more precise representation of an object within a scene than coarse instance masks generated by state of the art instance segmentation models. As a result, the computing system can provide a better understanding of a scene, thereby allowing robotic systems to complete complex manipulation tasks within an environment and generally improving perception systems of autonomous vehicles. Moreover, the enhanced polygons generated by the systems and methods of the present disclosure can increase the speed and efficiency of expensive annotation processes. Ultimately, the techniques disclosed herein result in more accurate annotation systems; thereby improving the training of perception systems and enhancing the safety of self-driving systems relying on such systems.

Furthermore, although aspects of the present disclosure focus on the application of annotation techniques described herein to object detection models utilized in autonomous vehicles, the systems and methods of the present disclosure can be used to annotate images for training any machine-learned model. Thus, for example, the systems and methods of the present disclosure can be used to train machine-learned models configured for image processing, labeling, etc.

Various means can be configured to perform the methods and processes described herein. For example, a computing system can include data obtaining unit(s), instance mask unit(s), initial polygon unit(s), feature extraction unit(s), deforming unit(s), enhancing unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s), etc.) can be configured to obtain data, for example, such as an input image including a plurality of datapoints indicative of an environment The means (e.g., instance mask unit(s), etc.) can be configured to determine an instance mask for an object instance within the environment by inputting the input image to a machine-learned instance segmentation model. The means (e.g., initial polygon unit(s), etc.) can be configured to determine one or more initial polygons for the object instance based, at least in part, on the instance mask. The one or more initial polygons, for example, can include a plurality of initial vertices defining one or more initial edges of the one or more initial polygons.

The means (e.g., feature extraction unit(s), etc.) can be configured to obtain a feature embedding including one or more features for one or more datapoints associated with the object instance. The means (e.g., deforming unit(s), etc.) can be configured to determine a vertex embedding based, at least in part, on the feature embedding and the one or more initial polygons. The vertex embedding can be indicative of the locations of one or more of the initial vertices of the one or more initial polygons. And, the means (e.g., enhancing unit(s), etc.) can be configured to generate one or more enhanced polygons for the object instance based, at least in part, on the vertex embedding and the one or more initial polygons. The one or more enhanced polygons can include a plurality of enhanced vertices defining one or more enhanced edges of the one or more enhanced polygons.

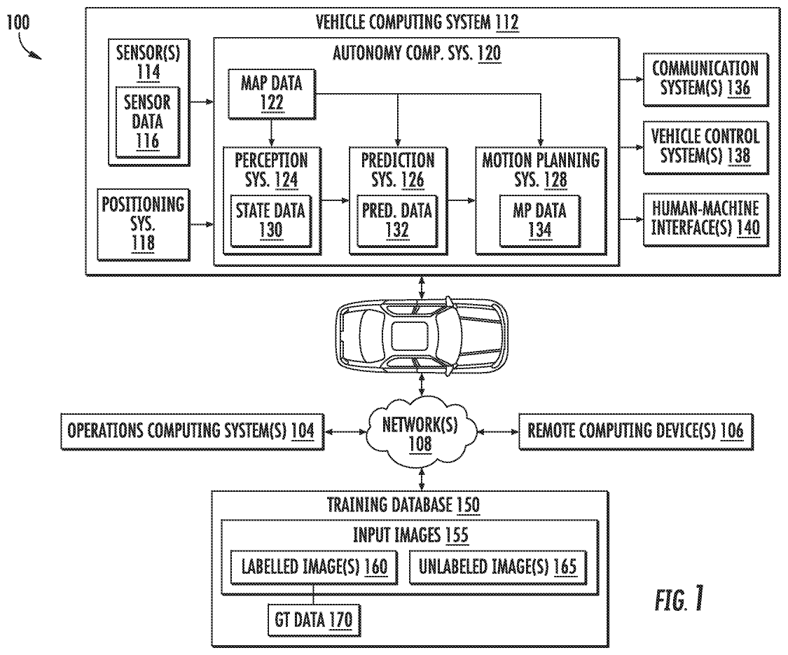

With reference now to FIGS. 1-8, example embodiments of the present disclosure will be discussed in further detail. FIG. 1 depicts an example system 100 overview according to example implementations of the present disclosure. More particularly, FIG. 1 illustrates a vehicle 102 (e.g., ground-based vehicle, bikes, scooters, and other light electric vehicles, etc.) including various systems and devices configured to control the operation of the vehicle. For example, the vehicle 102 can include an onboard vehicle computing system 112 (e.g., located on or within the autonomous vehicle) that is configured to operate the vehicle 102.

Generally, the vehicle computing system 112 can obtain sensor data 116 from a sensor system 114 onboard the vehicle 102, attempt to comprehend the vehicle's surrounding environment by performing various processing techniques on the sensor data 116, and generate an appropriate motion plan 134 through the vehicle's surrounding environment.

As illustrated, FIG. 1 shows a system 100 that includes the vehicle 102; a communications network 108; an operations computing system 104; one or more remote computing devices 106; the vehicle computing system 112; one or more sensors 114; sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; a human-machine interface 140; and a training database 150.

The operations computing system 104 can be associated with a service provider that can provide one or more vehicle services to a plurality of users via a fleet of vehicles that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can be configured to monitor and communicate with the vehicle 102 and/or its users to coordinate a vehicle service provided by the vehicle 102. To do so, the operations computing system 104 can communicate with the one or more remote computing devices 106 and/or the vehicle 102 via one or more communications networks including the communications network 108. The communications network 108 can send and/or receive signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. the Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 102 including sending and/or receiving data or signals to and from the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices such as, for example, one or more operator devices associated with one or more vehicle operators, user devices associated with one or more vehicle passengers, developer devices associated with one or more vehicle developers (e.g., a laptop/tablet computer configured to access computer software of the vehicle computing system 112), etc. One or more of the devices can receive input instructions from a user or exchange signals or data with an item or other computing device or computing system (e.g., the operations computing system 104). Further, the one or more remote computing devices 106 can be used to determine and/or modify one or more states of the vehicle 102 including a location (e.g., a latitude and longitude), a velocity, an acceleration, a trajectory, a heading, and/or a path of the vehicle 102 based in part on signals or data exchanged with the vehicle 102. In some implementations, the operations computing system 104 can include the one or more of the remote computing devices 106.

The vehicle 102 can be a ground-based vehicle (e.g., an automobile, a motorcycle, a train, a tram, a bus, a truck, a tracked vehicle, a light electric vehicle, a moped, a scooter, and/or an electric bicycle), an aircraft (e.g., airplane or helicopter), a boat, a submersible vehicle (e.g., a submarine), an amphibious vehicle, a hovercraft, a robotic device (e.g. a bipedal, wheeled, or quadrupedal robotic device), and/or any other type of vehicle. The vehicle 102 can be an autonomous vehicle that can perform various actions including driving, navigating, and/or operating, with minimal and/or no interaction from a human driver.

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 102 (e.g., within range or a field of view of one or more of the one or more sensors 114). The one or more sensors 114 can include one or more Light Detection and Ranging (LiDAR) systems, one or more Radio Detection and Ranging (RADAR) systems, one or more cameras (e.g., visible spectrum cameras and/or infrared cameras), one or more sonar systems, one or more motion sensors, and/or other types of image capture devices and/or sensors. The sensor data 116 can include image data, radar data, LiDAR data, sonar data, and/or other data acquired by the one or more sensors 114. The one or more objects can include, for example, pedestrians, vehicles, bicycles, buildings, roads, foliage, utility structures, bodies of water, and/or other objects. The one or more objects can be located on or around (e.g., in the area surrounding the vehicle 102) various parts of the vehicle 102 including a front side, rear side, left side, right side, top, or bottom of the vehicle 102. The sensor data 116 can be indicative of locations associated with the one or more objects within the surrounding environment of the vehicle 102 at one or more times. For example, sensor data 116 can be indicative of one or more LiDAR point clouds associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and/or location of different roadways, road segments, buildings, or other items or objects (e.g., lampposts, crosswalks and/or curbs); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine a position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing devices 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the sensor data 116 (e.g., LiDAR data, camera data) to match it to a map of the surrounding environment to get a determination of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the sensor data 116 from the one or more sensors 114, attempt to determine the state of the surrounding environment by performing various processing techniques on the sensor data 116 (and/or other data), and generate an appropriate motion plan through the surrounding environment, including for example, a motion plan that navigates the vehicle 102 around the current and/or predicted locations of one or more objects detected by the one or more sensors 114. The autonomy computing system 120 can control the one or more vehicle control systems 138 to operate the vehicle 102 according to the motion plan.

The autonomy computing system 120 can identify one or more objects that are proximate to the vehicle 102 based at least in part on the sensor data 116 and/or the map data 122. For example, the perception system 124 can obtain state data 130 descriptive of a current and/or past state of an object that is proximate to the vehicle 102. The state data 130 for each object can describe, for example, an estimate of the object's current and/or past: location and/or position; speed; velocity; acceleration; heading; orientation; size/footprint (e.g., as represented by a bounding shape); class (e.g., pedestrian class vs. vehicle class vs. bicycle class), and/or other state information. The perception system 124 can provide the state data 130 to the prediction system 126 (e.g., for predicting the movement of an object).

The prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128. In some implementations, the perception and prediction systems 124, 126 (and/or other systems) can be combined into one system and share computing resources.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include the one or more human-machine interfaces 140. For example, the vehicle computing system 112 can include one or more display devices located on the vehicle computing system 112. A display device (e.g., screen of a tablet, laptop and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a back passenger seat). For example, the autonomy computing system 120 can provide one or more outputs including a graphical display of the location of the vehicle 102 on a map of a geographical area within one kilometer of the vehicle 102 including the locations of objects around the vehicle 102. A passenger of the vehicle 102 can interact with the one or more human-machine interfaces 140 by touching a touchscreen display device associated with the one or more human-machine interfaces to indicate, for example, a stopping location for the vehicle 102.

The vehicle computing system 112 can communicate data between the vehicle 102 and the human-machine interface 140. The data can be communicated to and/or from the vehicle 102 directly and/or indirectly (e.g., via another computing system). For example, in some implementations, the data can be communicated directly from the vehicle computing system 112 to the human-machine interface 140. In addition, or alternatively, the vehicle computing system 112 can communicate with the human-machine interface 140 indirectly, via another computing system, such as, for example, a system of a third party vehicle provider/vendor.

In some implementations, each of the autonomous subsystems (e.g., perception system 124, prediction system 126, motion planning system 128, etc.) can utilize one or more machine-learned models. For example, a perception system 124, prediction system 126, etc. can perceive one or more object within the surrounding environment of the vehicle 102 by inputting sensor data 116 (e.g., LiDAR data, image data, voxelized LiDAR data, etc.) into one or more machine-learned models. By way of example, the autonomy system 120 can detect one or more objects within the surrounding environment of the vehicle 102 by including, employing, and/or otherwise leveraging one or more machine-learned models. For example, a perception system, prediction system, etc. can perceive one or more objects within the surrounding environment of the vehicle by inputting sensor data 114 (e.g., LiDAR data, image data, voxelized LiDAR data, etc.) into one or more machine-learned object detection models. The one or more object detection machine-learned models can be configured to receive the sensor data 114 associated with one or more objects within the surrounding environment of the vehicle 102 and detect the one or more objects within the surrounding environment based on the sensor data 114. For instance, the machine-learned object detection models can be previously trained to output a plurality of bounding boxes, classifications, etc. indicative of one or more of the one or more objects within a surrounding environment of the vehicle 102. In this manner, the autonomy system 120 can perceive the one or more objects within the surrounding environment of the vehicle 102 based, at least in part, on the one or more machine-learned models.

In some implementations, the one or more machine-learned models can be trained offline using one or more supervised training techniques. By way of example, a training computing system can train the machine-learned models using labelled training data. The training computing system can include and/or be a component of an operations computing system(s) 104 configured to monitor and communicate with the vehicle 102. In addition, or alternatively, the training computing system can include and/or be a component of one or more remote computing device(s) 106 such as, for example, one or more remote servers configured to communicate with the vehicle 102 (e.g., over network 108).

The training computing system can include and/or have access to a training database 150 including a plurality of input images 155 and ground truth data 170. The plurality of input images 155 can include one or more labelled input image(s) 160 and/or unlabeled input image(s) 165. The training database 150, for example, can include an image database including the plurality of input images 155. Each respective input image can include a plurality of respective datapoints (e.g., pixels) indicative of an environment. In addition, or alternatively, the training database 150 can include ground truth data 170. The ground truth data 170 can include one or more object instance classifications for one or more input images of the image database. For example, the ground truth data 170 can include one or more ground truth polygons for one or more of the input images 155. The ground truth polygon(s) can include enhanced polygon(s) for one or more object instances represented by one or more of the input images 155. In some implementations, the ground truth data 170 can be generated for the one or more input images using one or more machine-learning techniques.

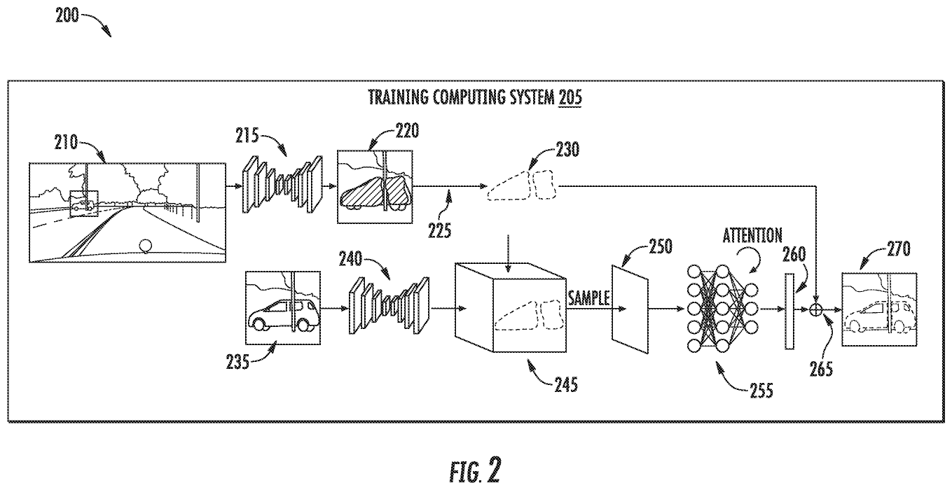

For example, FIG. 2 depicts a data flow diagram 200 for generating one or more enhanced polygons according to example implementations of the present disclosure. As illustrated, a training computing system 205 can receive an input image 210. The input image 210 can be analyzed by one or more machine learned models including instance segmentation model 215, feature extraction model 240, and/or a deforming model 255. These models can be configured to output one or more of an instance mask 220, one or more initial polygons 230, an object image 235, a feature embedding 245, a vertex embedding 250, and/or one or more enhanced polygons 270.

For example, the training computing system 205 can obtain an input image 210 from an image database. For instance, the input image 210 can be obtained from the training database 150 of FIG. 1 (e.g., during training) or from a data store onboard a vehicle (e.g., vehicle 102) that includes sensor data (e.g., sensor data 116) associated with a surrounding environment of the vehicle 102 (e.g., acquired via the vehicle's onboard sensor(s) 116). The input image 210 can include a plurality of datapoints indicative of an environment. For instance, the plurality of datapoints can include a plurality of image pixels of the input image 210. The training computing system 205 can determine an instance mask 220 for an object instance within the environment by inputting the input image 210 to a machine-learned instance segmentation model 215. For example, the training computing system 205 can include and/or have access to a machine-learned instance segmentation model 215 configured to output one or more object instances in response to receiving a respective input image 210 of the plurality of input images (e.g., input images 155 of training database 150).

The machine-learned instance segmentation model 215 can include any machine-learned model (e.g., deep neural networks, convolutional neural networks, recurrent neural networks, recursive neural networks, decision trees, logistic regression models, support vector machines, etc.). In some implementations, the machine-learned instance segmentation model 215 can include one or more modified instance segmentation models such as, for example, a unified panoptic segmentation network (UPSNet) model modified with a backbone from a convolution network (e.g., WideResNet38) model and one or more elements of a path aggregation network (PANet) model. In some implementations, the machine-learned instance segmentation model 215 can be pretrained on a database of labelled images such as labelled image(s) 160 of the training database 150 (e.g., a common object in context database (COCO)). A deformable convolution network can be used as its backbone.

The training computing system 205 can input the input image 210 to the machine-learned instance segmentation model 215 to receive a coarse instance mask 220 for the object instance. In some implementations, the training computing system 205 can receive a respective coarse instance mask 220 for each object instance represented by the input image 210. The instance mask 220 can include a coarse pixel-wise segmentation mask of the object instance. The coarse pixel-wise segmentation mask, for example, can include a plurality of labelled datapoints of the input image 210. For example, each respective datapoint of the input image 210 can be assigned a respective confidence score indicative of whether the respective datapoint corresponds to a portion of the object instance. The coarse pixel-wise segmentation mask can include a plurality of pixels of the input image 210 associated with a confidence score over a confidence threshold.

The training computing system 205 can determine one or more initial polygons 230 for the object instance based on the instance mask 220 (e.g., the coarse pixel-wise segmentation mask). For instance, the training computing system 205 can apply a contour algorithm 225 to extract one or more object contours (e.g., mask borders) from the instance mask 220. The contour algorithm 225, for example, can include a border following algorithm configured to extract the borders of instance mask 220. By way of example, the contour algorithm 225 can be configured to trace the borders of the instance mask 220 to determine a rough shape of the object instance (e.g., the one or more initial polygons 230).

The one or more initial polygons 230 can include a plurality of initial vertices defining one or more initial edges of the one or more initial polygons 230. The training computing system 205 can determine a plurality of initial vertices for the one or more initial polygons 230 based, at least in part, on the one or more object contours. For instance, the plurality of initial vertices can be placed an equal image pixel distance apart along the one or more object contours. As an example, the initial set of vertices can be placed every 10 pixels along the contour (e.g., border of the mask). In this manner, the training computing system 205 can initialize the polygon by using the contour algorithm 225 to extract the contours from the instance mask 220. The training computing system 205 can determine the initial set of vertices by placing a respective initial vertex at every 10 pixel distance in the contour. Such dense vertex interpolation can provide a good balance between performance and memory consumption.

The training computing system 205 can determine an object image 235 from the input image 210. The object image 235 can include one or more datapoints (e.g., pixels) of the plurality of datapoints of the input image 210. The object image 235 can include, for example, a cropped image from the input image 210. By way of example, the training computing system 205 can crop the input image 210 based, at least in part, on the instance mask 220. For instance, the training computing system 205 can fit a bounding box to the instance mask 220. In addition, or alternatively, the machine-learned instance segmentation model 215 can output a proposal box for the object instance. The training computing system 205 can crop the object image 235 from the input image 210 based at least in part on the bounding box and/or proposal box for the object instance mask 220.

The object image 235 can include one or more datapoints. By way of example, the one or more datapoints of the object image 235 can include a plurality of pixels. The plurality of pixels can be arranged in a square of equal dimensions. For example, the object image 235 can be resized (e.g., from the input image 210) to a square of pixels (e.g., 512 pixels by 512 pixels). As an example, the object image 235 can be resized to an image (H_{c}; W_{c})=(512; 512).

The training computing system 205 can obtain a feature embedding 245 including one or more features for one or more datapoints (e.g., the one or more datapoints of the object image 235) of the plurality of datapoints (e.g., the plurality of datapoints of the input image 210). For example, training computing system 205 can include a machine-learned feature extraction model 240 configured to output one or more features for one or more respective datapoints in response to receiving the respective datapoint(s). The machine-learned feature extraction model 240 can include any machine-learned model (e.g., deep neural networks, convolutional neural networks, recurrent neural networks, recursive neural networks, decision trees, logistic regression models, support vector machines, etc.).

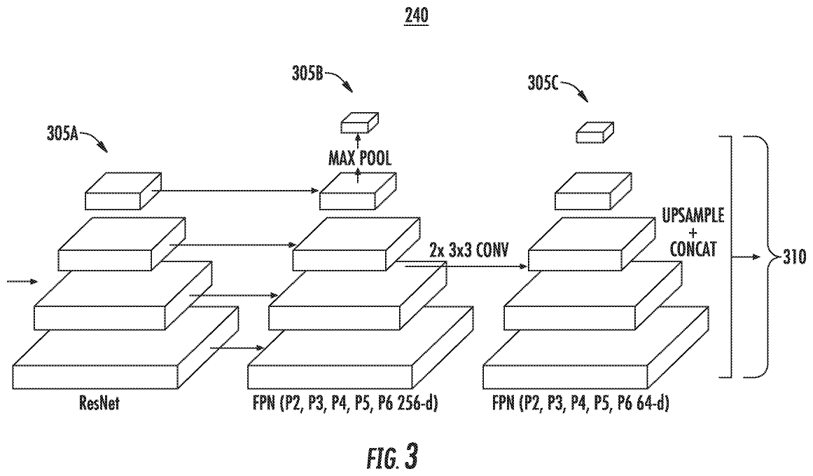

By way of example, FIG. 3 depicts an example feature extraction model 240 according to example implementations of the present disclosure. In some implementations, the machine-learned feature extraction model 240 can include a ResNet backbone 305a and one or more feature pyramid networks (FPNs) 305b-c that learn to make use of multi-scale features 310. For instance, the network can be configured to take as input the object image 235 (H_{c}; W_{c}) obtained from the instance initialization stage and output a set of features at different pyramid levels. In this manner, the machine-learned feature extraction model 240 can be configured to capture high curvature and complex shapes.

With reference to FIG. 2, the training computing system 205 can obtain the feature embedding 245 including the one or more features for the one or more datapoints of the plurality of datapoints by inputting the object image 235 to the machine-learned feature extraction model 240. The feature embedding 245, for example, can include one or more feature maps (e.g., P₂, P₃, P₄, P₅, P₆, etc.) for each datapoint (e.g., pixel) of the object image 235. By way of example, the feature embedding 245 can include, for each datapoint of the object image 235, a set of features (e.g., a feature map) at different pyramid levels (e.g., 310). The set of features can include a set of reliable deep features for each pixel of the object image 235 and/or the pixel's coordinates within the object image 235. In some implementations, the training computing system 205 can process a number of feature maps of the feature embedding 245 to get a feature map of three hundred and twenty layers for each pixel. The training computing system 205 can concatenate the feature map of three hundred and twenty layers to each respective pixel of the object image 235 to obtain a respective feature tensor with dimensions such as, for example, (320+2). In this manner, the training computing system 205 can obtain a feature embedding 245 (e.g., H×W×(320+2)) that includes a feature tensor for each datapoint of the one or more datapoints in the object image 235.

The training computing system 205 can determine a vertex embedding 250 based on the feature embedding 245 and the one or more initial polygons 230. The vertex embedding 250 can include a plurality of embedded vertices indicative of the locations of one or more of the initial vertices of the one or more initial polygons 230. For example, the plurality of embedded vertices can include an embedded vertex for each initial vertex of the plurality of initial vertices of the one or more initial polygons 230. By way of example, each initial vertex of the plurality of initial vertices of the one or more initial polygons 230 can correspond to unique vertex coordinates within the object image 235. The training computing system 205 can sample features at the vertex coordinates corresponding to the initial vertices of the one or more initial polygons 230 from the feature tensor for each datapoint of the one or more datapoints in the object image 235. In this manner, the training computing system 205 can obtain a feature tensor from the feature embedding 245 that corresponds to each initial vertex of the one or more initial polygons 230.

For example, the training computing system 205 can build the vertex embedding 250 upon the multi-scale features extracted from the backbone FPN network (e.g., the machine-learned feature extraction model 240). The training computing system 205 can take the P₂, P₃, P₄, P₅, and P₆ feature maps and apply a plurality of (e.g., two, etc.) lateral convolutional layers to each of them in order to reduce the number of feature channels from two-hundred and fifty-six to sixty-four. Since the feature maps are ¼, ⅛, 1/16, 1/32, and 1/64 of the original scale, the training computing system 205 can bilinearly upsample each feature map back to the original size and concatenate them to form a H_{c}×W_{c}×320 feature tensor. In addition, or alternatively, a two channel CoordConv layer can be appended to each vertex. For instance, the channels can represent x and y coordinates with respect to the frame of the object image 235. In some implementations, the training computing system 205 can exploit a bilinear interpolation operation, for example, from a spatial transformer network to sample features at each vertex coordinate corresponding to each initial vertex of the one or more initial polygons 230 to sample a feature tensor for each initial vertex. In this manner, the vertex embedding 250 (e.g., defined by z) can include an embedding with dimensions of N×(320+2) embedded vertices, where N is the number of initial vertices of the one or more initial polygons 230.

The training computing system 205 can generate a plurality of vertex offsets 260 for the one or more initial polygons 230 based on the vertex embedding 250. The plurality of vertex offsets 260 can include an offset for each initial vertex of the one or more initial polygons 230. By way of example, each respective initial vertex of the plurality of initial vertices can be indicative of initial coordinates of the input image 210. A respective vertex offset of the plurality of vertex offsets 260 can include a distance from the respective initial coordinates of a corresponding initial vertex.

For example, the training computing system 205 can generate the plurality of vertex offsets 260 by inputting the vertex embedding 250 to a machine-learned deforming model 255. By way of example, the training computing system 205 can include and/or have access to a machine-learned deforming model 255 configured to output a plurality of respective vertex offsets 260 in response to receiving a vertex embedding 250. The machine-learned deforming model 255 can include any machine-learned model (e.g., deep neural networks, convolutional neural networks, recurrent neural networks, recursive neural networks, decision trees, logistic regression models, support vector machines, etc.). As an example, in some implementations, the machine-learned deforming model 255 can include a self-attending transformer network. The self-attending transformer network can be configured to model dependencies among each of the plurality of embedded vertices of the vertex embedding 250.

For example, the machine-learned deforming model 255 can take the vertex embedding 250 as an input and, in response, output an offset for each initial vertex of the vertex embedding 250. The machine-learned deforming model 255 (e.g., the self-attending transformer network) can be configured to model dependencies between each of the plurality of embedded vertices of the vertex embedding 250. By way of example, the machine-learned deforming model 255 (e.g., the self-attending transformer network) can include three feed forward neural networks configured to transform a vertex embedding 250 into three different values. The training computing system 205 can compute weightings between each of the values by taking a softmax over the dot product of two of the values and multiplying by the third.

More particularly, the training computing system 205 can leverage an attention mechanism to propagate information across vertices of the one or more initial polygons 230. By way of example, moving one vertex can result in two edges attached to the vertex being moved as well. The movement of these edges can depend on the position of the neighboring vertices. Each vertex can communicate with one another in order to reduce unstable and overlapping behavior. The training computing system 205 can utilize the machine-learned deforming model 255 to represent the intricate dependencies between each vertex. Given the vertex embedding 250 (e.g., defined by z), the training computing system 205 can use three feed-forward neural networks to transform the vertex embeddings of the vertex embedding 250 into Q(z), K(z), and V(z), where Q, K, and V represent Query, Key, and Value, respectively. The training computing system 205 can compute the weightings between vertices by taking the softmax over the dot product Q(z)K(z)^{T}. The weighting can be multiplied with the keys V(z) to propagate dependencies across all vertices. By way of example, the attention mechanism can be written as:

$$Atten ( Q ( z ) ; K ( z ) ; V ( z ) ) = softmax ( \frac{Q ( z ) {K ( z )}^{T}}{\sqrt{{d}_{k}}} ) V ( z )$$

where dₖ can be dimension of the queries and keys, serving as a scaling factor to prevent extremely small gradients. The operation can be repeated multiple times (e.g., six times). After the last transformer layer, the training computing system 205 can feed the output to another feed-forward network that can predict N×2 offsets for each initial vertex of the one or more initial polygons 230.

The training computing system 205 can generate one or more enhanced polygons 270 for the object instance based on the vertex embedding 250 and the one or more initial polygons 230. The one or more enhanced polygons 270, for example, can include a plurality of enhanced vertices defining one or more enhanced edges of the one or more enhanced polygons 270. For instance, the training computing system 205 can determine the plurality of enhanced vertices of the one or more enhanced polygons 270 by applying, at (265), the plurality of vertex offsets 260 to the plurality of initial vertices of the one or more initial polygons 230. By way of example, in some implementations, the training computing system 205 can add the distance of the respective vertex offset to the respective initial coordinates of the corresponding initial vertex. In this manner, the plurality of vertex offsets 260 can be added to the one or more initial polygons 230 to transform the shape of the one or more initial polygons 230.

In some implementations, the training computing system 205 can identify the object associated with the object instance based on the one or more enhanced polygons 270. By way of example, the training computing system 205 can include a plurality of object representations indicative of one or more predefined objects potentially within an environment depicted by the input image 210. For instance, each object representation can indicate a shape of at least one of the one or more predefined objects. The training computing system 205 can compare the one or more enhanced polygons 270 to the plurality of object representations to match the shape of the one or more enhanced polygons 270 to at least one of the predefined objects. The training computing system 205 can identify the object associated with the object instance based at least in part on matching the shape of the one or more enhanced polygons 270 to the at least one predefined object.

The machine learned models (e.g., machine-learned instance segmentation model 215, machine-learned feature extraction model 240, machine-learned deforming model 255, etc.) described herein can be trained via one or more machine-learning techniques. For example, the training computing system 205 can train the machine-learned deforming model 255 and the machine-learned feature extraction model in an end-to-end manner. For instance, the training computing system 205 can minimize the weighted sum of two losses. The first loss can penalize the machine-learned models when the vertices deviate from the ground truth. The second loss (e.g., a standard deviation loss) can regularize the edges of the one or more enhanced polygons 270 to prevent overlap and unstable movement of the vertices.

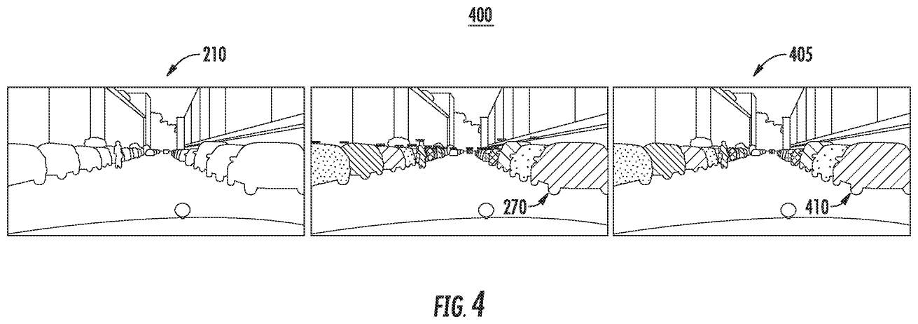

By way of example, FIG. 4 depicts an example training scenario according to example implementations of the present disclosure. The training computing system 205 can obtain a ground truth image 405 including at least one ground truth polygon 410 corresponding to the object instance of the input image 210 (e.g., from the training database 150). The training computing system 205 can determine a ground truth loss for the machine-learned deforming model 255 based on a comparison between the ground truth polygon 410 and the one or more enhanced polygons 270. For example, the training computing system 205 can determine a ground truth loss based on the ground truth polygon 410 and the one or more enhanced polygons 270 and train the machine-learned deforming model 255 to minimize the ground truth loss.

More particularly, in some implementations, the training computing system 205 can use a Chamfer Distance loss to move the vertices of the one or more enhanced polygons 270 (e.g., defined as P) closer to the ground truth polygon 410 (e.g., defined as Q). The Chamfer Distance loss can be defined as:

$${L}_{c} ( P , Q ) = \frac{1}{\vert P \vert} {\sum }_{i} {min}_{q ∈ Q} {‖ {p}_{i} - q ‖}_{2} + \frac{1}{\vert Q \vert} {\sum }_{j} {min}_{p ∈ P} {‖ p - {q}_{j} ‖}_{2}$$

where p and q can be the rasterized edge pixels of the one or more enhanced polygons 270, P, and the ground truth polygon 410, Q, respectively. The first term of the loss can penalize the machine-learned models when P is far from Q and the second term can penalize the models when Q is far from P.

In addition, or alternatively, the training computing system 205 can obtain a standard deviation loss for the one or more enhanced polygons 270. The standard deviation loss can be indicative of an average displacement of a distance between each of the enhanced vertices. In some implementations, the training computing system 205 can train the machine-learned deforming model 255 to minimize the standard deviation loss. By way of example, in order to prevent unstable movement of the vertices, the training computing system 205 can add a standard deviation loss on the lengths of the edges between the vertices. The standard deviation loss can be defined as:

$${L}_{s} ( P ) = \sqrt{\frac{Σ {‖ e - \overline{e} ‖}_{2}}{n}} ,$$

where e denotes the mean length of the edges. In this manner, the machine-learned models described herein can be learned to generate one or more enhanced polygons indicative of the precise, uniform shape of one or more object instances represented by an input image (e.g., input image 210).

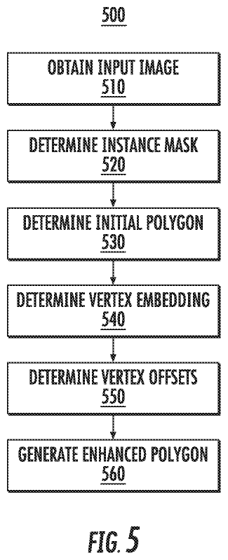

FIG. 5 depicts a flowchart of a method 500 for generating an enhanced object according to example implementations of the present disclosure. One or more portion(s) of the method 500 can be implemented by a computing system that includes one or more computing devices such as, for example, the computing systems described with reference to the other figures (e.g., training computing system 205, operations computing system(s) 104, remote computing device(s) 106, etc.). Each respective portion of the method 500 can be performed by any (or any combination) of one or more computing devices. Moreover, one or more portion(s) of the method 500 can be implemented as an algorithm on the hardware components of the device(s) described herein (e.g., as in FIGS. 1, 7, 8, etc.), for example, to generate an enhanced object. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 5 is described with reference to elements/terms described with respect to other systems and figures for exemplary illustrated purposes and is not meant to be limiting. One or more portions of method 500 can be performed additionally, or alternatively, by other systems.

At 510, the method 500 can include obtaining an input image. For example, a computing system (e.g., training computing system 205, etc.) can obtain an input image. For instance, the computing system can obtain an input image including a plurality of datapoints indicative of an environment. The plurality of datapoints, for example, can include a plurality of image pixels of the input image.

At 520, the method 500 can include determining an instance mask. For example, a computing system (e.g., training computing system 205, etc.) can determine an instance mask. For instance, the computing system can determine an instance mask for an object instance within the environment by inputting the input image to a machine-learned instance segmentation model. The instance mask, for example, can include a coarse pixel-wise segmentation mask of the object instance.

At 530, the method 500 can include determining one or more initial polygons. For example, a computing system (e.g., training computing system 205, etc.) can determine one or more initial polygons. For instance, the computing system can determine one or more initial polygons for the object instance based, at least in part, on the instance mask. The one or more initial polygons, for example, can include a plurality of initial vertices defining one or more initial edges of the one or more initial polygons. For example, a respective initial vertex of the plurality of initial vertices can be indicative of initial coordinates of the input image. In some implementations, the computing system can determine the one or more initial polygons by applying a contour algorithm to extract one or more object contours from the instance mask. For example, the computing system can determine the plurality of initial vertices for the one or more initial polygons based, at least in part, on the one or more object contours. The plurality of initial vertices, for example, can be placed an equal image pixel distance apart along the one or more object contours.

At 540, the method 500 can include determining a vertex embedding. For example, a computing system (e.g., training computing system 205, etc.) can determine a vertex embedding. For instance, the computing system can determine a vertex embedding based, at least in part, on a feature embedding and the one or more initial polygons. The vertex embedding can be indicative of the locations of one or more of the initial vertices of the one or more initial polygons.

At 550, the method 500 can include determining vertex offsets. For example, a computing system (e.g., training computing system 205, etc.) can determine vertex offsets. For instance, the computing system can determine a plurality of vertex offsets by inputting the vertex embedding to a machine-learned deforming model. The plurality of vertex offsets can include a vertex offset for each initial vertex of the plurality of initial vertices. For example, a respective vertex offset of the plurality of vertex offsets can include a distance from respective initial coordinates of a corresponding initial vertex.

At 560, the method 500 can include generating one or more enhanced polygons. For example, a computing system (e.g., training computing system 205, etc.) can generate one or more enhanced polygons. For instance, the computing system can generate one or more enhanced polygons for the object instance based, at least in part, on the vertex embedding and the one or more initial polygons. For instance, the computing system can model the dependencies among the plurality of initial vertices of the one or more initial polygons. For example, the one or more enhanced polygons can include a plurality of enhanced vertices defining one or more enhanced edges of the one or more enhanced polygons. In some implementations, the computing can determine the plurality of enhanced vertices of the one or more enhanced polygons by applying the plurality of vertex offsets to the plurality of initial vertices of the one or more initial polygons. By way of example, the computing system can add the distance of the respective vertex offset to the respective initial coordinates of the corresponding initial vertex.

In some implementations, the computing system can be onboard an autonomous vehicle. In such a case, the method 500 can further include identifying the object associated with the object instance based, at least in part, on the one or more enhanced polygons. Moreover, the method 500 can include training the one or more machine-learned models discussed herein. For example, the method can include obtaining a ground truth polygon corresponding to the object instance, determining a ground truth loss for the machine-learned deforming model based, at least in part, on a comparison between the ground truth polygon and the one or more enhanced polygons, and training the machine-learned deforming model to minimize the ground truth loss. In addition, or alternatively, the method 500 can include obtaining a standard deviation loss for the one or more enhanced polygons and training the machine-learned deforming model to minimize the standard deviation loss. The standard deviation loss, for example, can be indicative of an average displacement of a distance between each of the enhanced vertices.

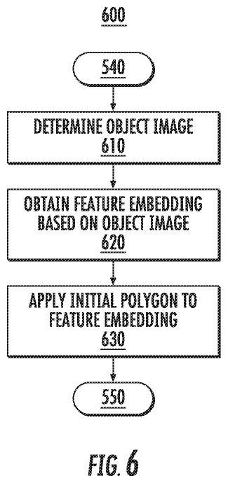

FIG. 6 depicts a flowchart of a method 600 for determining a vertex embedding according to example implementations of the present disclosure. One or more portion(s) of the method 600 can be implemented by a computing system that includes one or more computing devices such as, for example, the computing systems described with reference to the other figures (e.g., training computing system 205, operations computing system(s) 104, remote computing device(s) 106, etc.). Each respective portion of the method 600 can be performed by any (or any combination) of one or more computing devices. Moreover, one or more portion(s) of the method 600 can be implemented as an algorithm on the hardware components of the device(s) described herein (e.g., as in FIGS. 1, 7, 8, etc.), for example, to determine a vertex embedding. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 6 is described with reference to elements/terms described with respect to other systems and figures for exemplary illustrated purposes and is not meant to be limiting. One or more portions of method 600 can be performed additionally, or alternatively, by other systems.

Method 600 begins at step/operation 540 of method 500 where the method 500 includes determining a vertex embedding. At 610, the method 600 can include determining an object image. For example, a computing system (e.g., training computing system 205, etc.) can determine an object image. For instance, the computing system can determine an object image from the input image. The object image, for example, can include one or more datapoints of the plurality of datapoints. The computing system can, for example, crop the input image based, at least in part, on the instance mask. By way of example, the computing system can fit a bounding box to the instance mask and crop the input image based at least in part on the bounding box.

At 620, the method 600 can include obtaining a feature embedding based on the object image. For example, a computing system (e.g., training computing system 205, etc.) can obtain a feature embedding based on the object image. For instance, the computing system can obtain a feature embedding including one or more features for one or more datapoints associated with the object instance. In some implementations, the computing system can obtain the feature embedding including the one or more features for the one or more datapoints of the plurality of datapoints by inputting the object image to a machine-learned feature extraction model. The feature embedding can include a feature tensor for each of the one or more datapoints of the object image.

At 630, the method 600 can include applying one or more initial polygons to the feature embedding. For example, a computing system (e.g., training computing system 205, etc.) can apply the one or more initial polygons to the feature embedding. In this manner, the computing system can obtain a vertex embedding for the one or more initial polygons that includes a feature tensure for each vertex of the one or more initial polygons. Method 600 can then proceed to step 550 of method 500 where method 500 includes determine the vertex offsets based, at least in part, on the feature tensure associated with each vertex embedding.

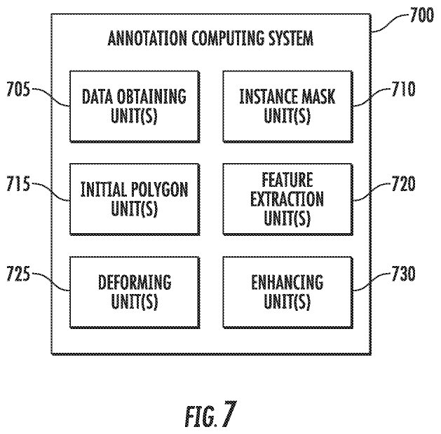

FIG. 7 depicts example annotation computing system 700 with various means for performing operations and functions according example implementations of the present disclosure. One or more operations and/or functions in FIG. 7 can be implemented and/or performed by one or more devices (e.g., one or more remote computing devices 106) or systems including, for example, the training computing system 205, the operations computing system 104, the vehicle 108, or the vehicle computing system 112, which are shown throughout the Figures.

Various means can be configured to perform the methods and processes described herein. For example, a computing system can include data obtaining unit(s) 705, instance mask unit(s) 710, initial polygon unit(s) 715, feature extraction unit(s) 720, deforming unit(s) 725, enhancing unit(s) 730, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s) 705, etc.) can be configured to obtain data, for example, such as an input image including a plurality of datapoints indicative of an environment The means (e.g., instance mask unit(s) 710, etc.) can be configured to determine an instance mask for an object instance within the environment by inputting the input image to a machine-learned instance segmentation model. The means (e.g., initial polygon unit(s) 715, etc.) can be configured to determine one or more initial polygons for the object instance based, at least in part, on the instance mask. The one or more initial polygons, for example, can include a plurality of initial vertices defining one or more initial edges of the one or more initial polygons.

The means (e.g., feature extraction unit(s) 720, etc.) can be configured to obtain a feature embedding including one or more features for one or more datapoints associated with the object instance. The means (e.g., deforming unit(s) 725, etc.) can be configured to determine a vertex embedding based, at least in part, on the feature embedding and the one or more initial polygons. The vertex embedding can be indicative of the locations of one or more of the initial vertices of the one or more initial polygons. And, the means (e.g., enhancing unit(s) 730, etc.) can be configured to generate one or more enhanced polygons for the object instance based, at least in part, on the vertex embedding and the one or more initial polygons. The one or more enhanced polygons can include a plurality of enhanced vertices defining one or more enhanced edges of the one or more enhanced polygons. Additionally, or alternatively, the means can be configured to other operations and functions described and/or claimed herein.

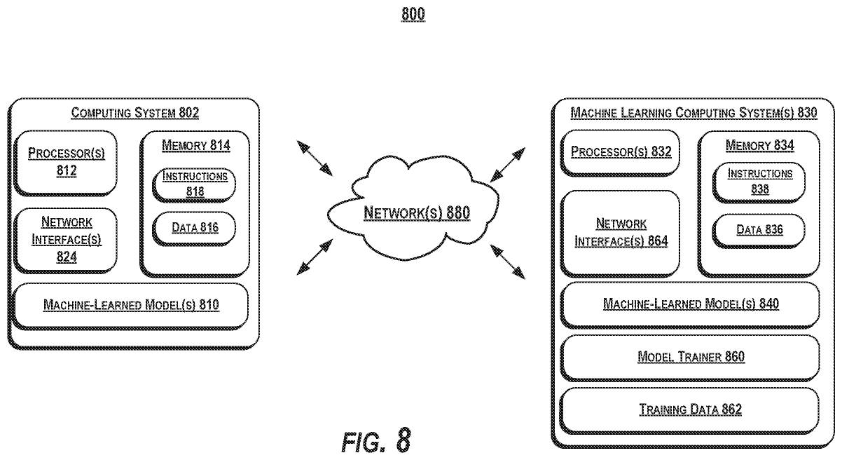

FIG. 8 depicts a block diagram of an example computing system 800 according to example embodiments of the present disclosure. The example system 800 includes a computing system 802 and a machine learning computing system 830 that are communicatively coupled over a network 880. In other implementations, the computing system 802 is not located on-board the autonomous vehicle. For example, the computing system 802 can operate offline to predict instance geometry. The computing system 802 can include one or more distinct physical computing devices.

The computing system 802 includes one or more processors 812 and a memory 814. The one or more processors 812 can be any suitable processing device (e.g., a processor core, a microprocessor, an ASIC, a FPGA, a controller, a microcontroller, etc.) and can be one processor or a plurality of processors that are operatively connected. The memory 814 can include one or more non-transitory computer-readable storage media, such as RAM, ROM, EEPROM, EPROM, one or more memory devices, flash memory devices, etc., and combinations thereof.

The memory 814 can store information that can be accessed by the one or more processors 812. For instance, the memory 814 (e.g., one or more non-transitory computer-readable storage mediums, memory devices) can store data 816 that can be obtained, received, accessed, written, manipulated, created, and/or stored. The data 816 can include, for instance, training data, image data, ground truth data, etc. and/or any other data described herein. In some implementations, the computing system 802 can obtain data from one or more memory device(s) that are remote from the system 802.

The memory 814 can also store computer-readable instructions 818 that can be executed by the one or more processors 812. The instructions 818 can be software written in any suitable programming language or can be implemented in hardware. Additionally, or alternatively, the instructions 818 can be executed in logically and/or virtually separate threads on processor(s) 812.

For example, the memory 814 can store instructions 818 that when executed by the one or more processors 812 cause the one or more processors 812 to perform any of the operations and/or functions described herein, including, for example, obtaining an input image, determining an instance mask, determining one or more initial polygons, obtaining a feature embedding, determining a vertex embedding, generating one or more enhanced polygons and/or any other operation or function described herein.

According to an aspect of the present disclosure, the computing system 802 can store or include one or more machine-learned models 810. As examples, the machine-learned models 810 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

In some implementations, the computing system 802 can receive the one or more machine-learned models 810 from the machine learning computing system 830 over network 880 and can store the one or more machine-learned models 810 in the memory 814. The computing system 802 can then use or otherwise implement the one or more machine-learned models 810 (e.g., by processor(s) 812). In particular, the computing system 802 can implement the machine learned model(s) 810 to generate one or more enhanced polygons for an object depicted by an input image.

The machine learning computing system 830 includes one or more processors 832 and a memory 834. The one or more processors 832 can be any suitable processing device (e.g., a processor core, a microprocessor, an ASIC, a FPGA, a controller, a microcontroller, etc.) and can be one processor or a plurality of processors that are operatively connected. The memory 834 can include one or more non-transitory computer-readable storage media, such as RAM, ROM, EEPROM, EPROM, one or more memory devices, flash memory devices, etc., and combinations thereof.

The memory 834 can store information that can be accessed by the one or more processors 832. For instance, the memory 834 (e.g., one or more non-transitory computer-readable storage mediums, memory devices) can store data 836 that can be obtained, received, accessed, written, manipulated, created, and/or stored. The data 836 can include, for instance, training data, image data, ground truth data, and/or any other data described herein. In some implementations, the machine learning computing system 830 can obtain data from one or more memory device(s) that are remote from the system 830.

The memory 834 can also store computer-readable instructions 838 that can be executed by the one or more processors 832. The instructions 838 can be software written in any suitable programming language or can be implemented in hardware. Additionally, or alternatively, the instructions 838 can be executed in logically and/or virtually separate threads on processor(s) 832.

For example, the memory 834 can store instructions 838 that when executed by the one or more processors 832 cause the one or more processors 832 to perform any of the operations and/or functions described herein, including, for example, obtaining an input image, determining an instance mask, determining one or more initial polygons, obtaining a feature embedding, determining a vertex embedding, generating one or more enhanced polygons and/or any other operation or function described herein.

In some implementations, the machine learning computing system 830 includes one or more server computing devices. If the machine learning computing system 830 includes multiple server computing devices, such server computing devices can operate according to various computing architectures, including, for example, sequential computing architectures, parallel computing architectures, or some combination thereof.

In addition, or alternatively to the model(s) 810 at the computing system 802, the machine learning computing system 830 can include one or more machine-learned models 840. As examples, the machine-learned models 840 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

As an example, the machine learning computing system 830 can communicate with the computing system 802 according to a client-server relationship. For example, the machine learning computing system 840 can implement the machine-learned models 840 to provide a web service to the computing system 802. For example, the web service can provide an input image, an instance mask, one or more initial polygons, a feature embedding, a vertex embedding, one or more enhanced polygons, etc. in accordance with any operation or function described herein.

Thus, machine-learned models 810 can located and used at the computing system 802 and/or machine-learned models 840 can be located and used at the machine learning computing system 830.

In some implementations, the machine learning computing system 830 and/or the computing system 802 can train the machine-learned models 810 and/or 840 through use of a model trainer 860. The model trainer 860 can train the machine-learned models 810 and/or 840 using one or more training or learning algorithms. One example training technique is backwards propagation of errors. In some implementations, the model trainer 860 can perform supervised training techniques using a set of labeled training data. In other implementations, the model trainer 860 can perform unsupervised training techniques using a set of unlabeled training data. The model trainer 860 can perform a number of generalization techniques to improve the generalization capability of the models being trained. Generalization techniques include weight decays, dropouts, or other techniques.

In particular, the model trainer 860 can train a machine-learned model 910 and/or 840 based on a set of training data 862. The training data 862 can include, for example, input images of a training database (e.g., training database 150 of FIG. 1). The model trainer 860 can be implemented in hardware, firmware, and/or software controlling one or more processors.

The computing system 802 can also include a network interface 824 used to communicate with one or more systems or devices, including systems or devices that are remotely located from the computing system 802. The network interface 824 can include any circuits, components, software, etc. for communicating with one or more networks (e.g., 880). In some implementations, the network interface 824 can include, for example, one or more of a communications controller, receiver, transceiver, transmitter, port, conductors, software and/or hardware for communicating data. Similarly, the machine learning computing system 830 can include a network interface 864.

The network(s) 880 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 880 can be accomplished, for instance, via a network interface using any type of protocol, protection scheme, encoding, format, packaging, etc.

FIG. 8 illustrates one example computing system 800 that can be used to implement the present disclosure. Other computing systems can be used as well. For example, in some implementations, the computing system 802 can include the model trainer 860 and the training dataset 862. In such implementations, the machine-learned models 810 can be both trained and used locally at the computing system 802. As another example, in some implementations, the computing system 802 is not connected to other computing systems.

In addition, components illustrated and/or discussed as being included in one of the computing systems 802 or 830 can instead be included in another of the computing systems 802 or 830. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Computing tasks discussed herein as being performed at computing device(s) remote from a vehicle/system can instead be performed at a vehicle/system (e.g., via the vehicle computing system), or vice versa. Such configurations can be implemented without deviating from the scope of the present disclosure.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, the method comprising:
obtaining, by a computing system comprising one or more computing devices, an input image comprising a plurality of datapoints indicative of an environment;
determining, by the computing system, an instance mask for an object instance within the environment by inputting the input image to a machine-learned instance segmentation model;
determining, by the computing system, one or more initial polygons for the object instance based, at least in part, on the instance mask, wherein the initial polygon comprises a plurality of initial vertices defining one or more initial edges of the one or more initial polygons;
obtaining, by the computing system, a feature embedding comprising one or more features for one or more datapoints associated with the object instance;
determining, by the computing system, a vertex embedding based, at least in part, on the feature embedding and the one or more initial polygons, wherein the vertex embedding is indicative of the locations of one or more of the initial vertices of the one or more initial polygons; and
generating, by the computing system, one or more enhanced polygons for the object instance based, at least in part, on the vertex embedding and the one or more initial polygons, wherein the one or more enhanced polygons comprise a plurality of enhanced vertices defining one or more enhanced edges of the one or more enhanced polygons.

2. The computer-implemented method of claim 1, wherein generating the one or more enhanced polygons for the object instance based, at least in part, on the vertex embedding and the initial polygon comprises:
determining, by the computing system, a plurality of vertex offsets by inputting the vertex embedding to a machine-learned deforming model; and
determining, by the computing system, the plurality of enhanced vertices of the one or more enhanced polygons by applying the plurality of vertex offsets to the plurality of initial vertices of the one or more initial polygons.

3. The computer-implemented method of claim 2, wherein the plurality of vertex offsets comprise a vertex offset for each initial vertex of the plurality of initial vertices,
wherein a respective initial vertex of the plurality of initial vertices is indicative of initial coordinates of the input image, and
wherein a respective vertex offset of the plurality of vertex offsets comprises a distance from respective initial coordinates of a corresponding initial vertex.

4. The computer-implemented method of claim 3, wherein determining the plurality of enhanced vertices of the one or more enhanced polygons by applying the plurality of vertex offsets to the plurality of initial vertices comprises:
adding, by the computing system, the distance of the respective vertex offset to the respective initial coordinates of the corresponding initial vertex.

5. The computer-implemented method of claim 1, wherein generating the one or more enhanced polygons for the object instance based, at least in part, on the vertex embedding and the one or more initial polygons comprises:
modeling, by the computing system, dependencies among the plurality of initial vertices.

6. The computer-implemented method of claim 1, further comprising:
determining, by the computing system, an object image from the input image, wherein the object image comprises one or more datapoints of the plurality of datapoints; and
obtaining, by the computing system, the feature embedding comprising the one or more features for the one or more datapoints of the plurality of datapoints by inputting the object image to a machine-learned feature extraction model.

7. The computer-implemented method of claim 6, wherein determining the object image from the input image comprises:
cropping, by the computing system, the input image based, at least in part, on the instance mask.

8. The computer-implemented method of claim 7, wherein cropping the input image based, at least in part, on the instance mask comprises:
fitting, by the computing system, a bounding box to the instance mask; and
cropping, by the computing system, the input image based at least in part on the bounding box.

9. The computer-implemented method of claim 5, wherein the feature embedding comprises a feature tensor for each of the one or more datapoints of the object image.

10. The computer-implemented method of claim 1, wherein the plurality of datapoints comprise a plurality of image pixels of the input image; and
wherein the instance mask comprises a coarse pixel-wise segmentation mask of the object instance.

11. The computer-implemented method of claim 10, wherein determining the one or more initial polygons for the object instance based, at least in part, on the instance mask comprises:
applying, by the computing system, a contour algorithm to extract one or more object contours from the instance mask; and
determining, by the computing system, the plurality of initial vertices for the one or more initial polygons based, at least in part, on the one or more object contours.

12. The computer-implemented method of claim 11, wherein the plurality of initial vertices is placed an equal image pixel distance apart along the one or more object contours.

13. The computer-implemented method of claim 1, wherein the computing system is on board an autonomous vehicle, and wherein the method further comprises:
identifying, by the computing system, the object associated with the object instance based, at least in part, on the one or more enhanced polygons.

14. A computing system comprising:
one or more processors; and
one or more non-transitory computer-readable media that collectively store instructions that, when executed by the one or more processors, cause the system to perform operations, the operations comprising:
obtaining an instance mask for an object instance within an environment depicted by an input image comprising a plurality of datapoints;
determining one or more initial polygons for the object instance based, at least in part, on the instance mask, wherein the one or more initial polygons comprise a plurality of initial vertices defining one or more initial edges of the one or more initial polygons;
obtaining a feature embedding comprising one or more features for one or more datapoints associated with the object instance;
determining a vertex embedding based, at least in part, on the feature embedding and the one or more initial polygons, wherein the vertex embedding is indicative of the locations of one or more of the initial vertices of the one or more initial polygons;
generating a plurality of vertex offsets by inputting the vertex embedding to a machine-learned deforming model; and
generating one or more enhanced polygons based, at least in part, on the plurality of vertex offsets and the plurality of initial vertices, wherein the one or more enhanced polygons comprise a plurality of enhanced vertices defining one or more enhanced edges of the one or more enhanced polygons.

15. The computing system of claim 14, wherein obtaining the instance mask for the object instance within the environment depicted by the input image comprises:
obtaining the input image comprising the plurality of datapoints indicative of the environment; and
determining, by the computing system, an instance mask for the object instance within the environment by inputting the input image to a machine-learned instance segmentation model.

16. The computing system of claim 14, wherein the operations further comprise:
obtaining a ground truth polygon corresponding to the object instance;
determining a ground truth loss for the machine-learned deforming model based, at least in part, on a comparison between the ground truth polygon and the one or more enhanced polygons; and
training the machine-learned deforming model to minimize the ground truth loss.

17. The computing system of claim 14, wherein the operations further comprise:
obtaining a standard deviation loss for the one or more enhanced polygons, wherein the standard deviation loss is indicative of an average displacement of a distance between each of the enhanced vertices; and
training the machine-learned deforming model to minimize the standard deviation loss.

18. A computing system, comprising:
an image database comprising a plurality of input images, wherein each respective input image comprises a plurality of respective datapoints indicative of an environment;
a machine-learned instance segmentation model configured to output one or more object instances in response to receiving a respective input image of the plurality of input images;
a memory that stores a set of instructions; and
one or more processors which are configured to use the set of instructions to:
obtain an input image from the image database;
determine an instance mask for an object instance within an environment of the input image by inputting the input image to the machine-learned instance segmentation model;
determine one or more initial polygons for the object instance based, at least in part, on the instance mask, wherein the one or more initial polygons comprise a plurality of initial vertices defining one or more initial edges of the one or more initial polygons;
obtain a feature embedding comprising one or more features for one or more datapoints associated with the object instance;
determine a vertex embedding based, at least in part, on the feature embedding and the one or more initial polygons, wherein the vertex embedding is indicative of the locations of one or more of the initial vertices of the one or more initial polygons; and
generate one or more enhanced polygons for the object instance based, at least in part, on the vertex embedding and the one or more initial polygons, wherein the one or more enhanced polygons comprise a plurality of enhanced vertices defining one or more enhanced edges of the one or more enhanced polygons.

19. The computing system of claim 18, further comprising:
a machine-learned feature extraction model configured to output one or more features for one or more respective datapoints in response to receiving the one or more respective datapoints;
wherein the one or more processors are configured to use the set of instructions to:
obtain an object image from the input image, wherein the object image comprises one or more datapoints of the plurality of datapoints; and
determine the feature embedding by inputting the object image to the machine-learned feature extraction model.

20. The computing system of claim 18, further comprising:
a machine-learned deforming model configured to output a plurality of respective vertex offsets in response to receiving a respective vertex embedding;
wherein the one or more processors are configured to use the set of instructions to:
determine a plurality of vertex offsets by inputting the vertex embedding to the machine-learned deforming model; and
determine the plurality of enhanced vertices of the one or more enhanced polygons by applying the plurality of vertex offsets to the plurality of initial vertices.
